(19) United States
(12) Patent Application Publication
(10) Pub. No.: US 2009/0046165 A1
(43) Pub. Date: Feb. 19, 2009

(54) PHOTOGRAPHING DEVICE

(76) Inventor: Yasunori KATO, Miyagi (JP)

Correspondence Address: BIRCH STEWART KOLASCH & BIRCH, PO BOX 747, FALLS CHURCH, VA, 22040-0747, US

(21) Appl. No.: 12/191,074

(22) Filed: Aug. 13, 2008

(30) Foreign Application Priority Data
Aug. 17, 2007 (JP) 2007-212855

(51) Int. Cl. H04N 5/228; G06K 9/00

(52) U.S. Cl. 348/222.1; 382/118; 348/E05.031

(57) ABSTRACT

A face region, that is a region of a face of a person, is detected by a face detecting circuit from a subject of photographing that is expressed by image information acquired by a CCD area sensor. Then, an operation portion is operated at a time of switching a photographing mode between a face detection photographing mode and an ordinary photographing mode. Interlockingly with operation with respect to the operation portion, a CPU switches between shifting to a color tone correcting mode that carries out correction of color tone defects in a case in which the color tone defects arise in pupil regions that are regions of pupils of a person in the subject of photographing expressed by the photographed image information, and reverting from the color tone correcting mode.

### CROSS-REFERENCE TO RELATED APPLICATION

This application claims priority under 35 USC 119 from Japanese Patent Application No. 2007-212855, the disclosure of which is incorporated by reference herein.

### BACKGROUND OF THE INVENTION

1. Field of the Invention

The present invention relates to a photographing device, and in particular, to a photographing device having a face detection photographing mode that carries out photographing under photographing conditions that are based on a face region and obtains photographed image information.

2. Description of the Related Art

When a subject of photographing is photographed by a camera, there are cases in which the color tone of the subject of photographing in the image acquired by photographing and the actual color tone differ greatly due to the state of reflection of light at the time of photographing. For example, if a person is photographed from the front while a flash is made to emit light, the flash light is incident from the front on the eyes of the person whose pupils are open in a dark place, and is reflected regularly thereby. Due thereto, there are cases in which a color tone defect (so-called “red-eye”), that tinges the pupils of the person in the image acquired by photographing with a red color or a gold color, arises.

In order to overcome this problem, Japanese Patent Application Laid-Open (JP-A) No. 2005-191687 discloses the following technique. A red-eye correcting mode switch, that is for instructing a shift to a red-eye correcting mode that carries out red-eye correction, is provided at a digital camera. If the mode is shifted to the red-eye correcting mode by the switch being operated, the pupil regions of a person are detected from the photographed image information that is acquired by photographing the subject of photographing. It is judged whether or not the detected pupil regions are red eyes. If they are red eyes, it is judged whether or not they are of a level such that red-eye correction should be carried out. If it is judged that they are of a level such that correction should be carried out, red-eye correction is carried out.

However, in the technique disclosed in JP-A No. 2005-191687, an exclusive-use operation portion (the switch) that is operated at the time of causing a shift to the red-eye correcting mode must be provided. As a result, there is the problem that this leads to an increase in the cost of the device and an increase in the size of the device.

### SUMMARY OF THE INVENTION

The present invention was developed in order to overcome the above-described problem, and an object thereof is to provide a photographing device that can carry out switching to a color tone correcting mode that carries out correction of color tone defects, without leading to an increase in cost or an increase in size.

In order to achieve the above object, a first aspect of the present invention is a photographing device including: an image pickup unit picking-up a subject of photographing and acquiring image information expressing the subject of photographing; a face detecting unit detecting a face region, that is a region of a face of a person, from the subject of photographing expressed by the image information acquired by the image pickup unit; an operation portion operated at a time of switching a photographing mode between a face detection photographing mode that, in a case in which a photographing execution instruction is inputted, carries out photographing that uses the image pickup unit and that is accompanied by detection of a face region by the face detecting unit, and obtains photographed image information, and an ordinary photographing mode that, in a case in which a photographing execution instruction is inputted, carries out photographing using the image pickup unit and without carrying out detection of the face region, and obtains photographed image information; and a switching unit that, interlockingly with operation with respect to the operation portion, switches between shifting to a color tone correcting mode that carries out correction of color tone defects in a case in which the color tone defects arise in pupil regions that are regions of pupils of a person in the subject of photographing expressed by the photographed image information, and reverting from the color tone correcting mode.

In accordance with the photographing device of the first aspect of the present invention, a subject of photographing is picked-up by the image pickup unit, and image information expressing the subject of photographing is acquired. A face region, which is the region of the face of a person, is detected by the face detecting unit from the subject of photographing that is expressed by the image information acquired by the image pickup unit.

Note that solid state image pickup elements such as a CCD (Charge Coupled Device) area sensor, a CMOS (Complementary Metal-Oxide Semiconductor) image sensor, and the like are examples of the image pickup unit.

In the photographing device of the first aspect of the present invention, the operation portion is operated at the time of switching the photographing mode between a face detection photographing mode and an ordinary photographing mode. The face detection photographing mode is a photographing mode that, in a case in which a photographing execution instruction is inputted, carries out photographing that uses the image pickup unit and that is accompanied by detection of a face region by the face detecting unit, and obtains photographed image information. The ordinary photographing mode is a photographing mode that in a case in which a photographing execution instruction is inputted, carries out photographing using the image pickup unit and without carrying out detection of the face region, and obtains photographed image information. Further, in the present invention, interlockingly with operation with respect to the operation portion, the switching unit switches between shifting to a color tone correcting mode that carries out correction of color tone defects in a case in which the color tone defects arise in pupil regions that are regions of pupils of a person in the subject of photographing expressed by the photographed image information, and reverting from the color tone correcting mode.

Various types of switches such as a slide switch, a push switch, a rotary switch, and the like are examples of the operation portion.

Namely, in the photographing device of the first aspect of the present invention, the operation portion, that is operated at the time of switching the photographing mode between the face detection photographing mode and the ordinary photographing mode, is also used to switch between shifting to the color tone correcting mode and reverting from the color tone correcting mode. In this way, shifting to the color tone correcting mode is possible without leading to an increase in the cost or an increase in the size of the device.

In this way, in accordance with the photographing device of the first aspect of the present invention, shifting to the color tone correcting mode and reverting from the color tone correcting mode are switched between, interlockingly with operation on the operation portion that is operated at the time of switching the photographing mode. Therefore, it is possible to switch to the color tone correcting mode without leading to an increase in cost and an increase in size.

Examples of the photographing device are information devices having a photographing function, such as a digital electronic still camera, a digital video camera, a cell phone, a PDA (Personal Digital Assistant: a portable information terminal), and the like.

In the photographing device of the first aspect of the present invention, the operation portion may be operated at a time of switching a photographing mode among a first photographing mode that executes the face detection photographing mode and the color tone correcting mode, a second photographing mode that executes the face detection photographing mode and does not execute the color tone correcting mode, and a third photographing mode that executes the ordinary photographing mode and does not execute the color tone correcting mode. In this way, the photographing mode can be switched among the first photographing mode, the second photographing mode and the third photographing mode, without leading to an increase in cost or an increase in size.

Further, in the photographing device of the first aspect of the present invention, the operation portion may be operated at a time of switching a photographing mode between a first photographing mode that executes the face detection photographing mode and the color tone correcting mode, and a third photographing mode that executes the ordinary photographing mode and does not execute the color tone correcting mode. In this way, the photographing mode can be switched between the first photographing mode and the third photographing mode, without leading to an increase in cost or an increase in size.

The photographing device of the first aspect of the present invention may further have a light-emitting unit carrying out light emission for compensating for a light amount insufficiency at a time of photographing the subject of photographing, and a first prohibiting unit prohibiting shifting to the color tone correcting mode by the switching unit in a case in which the light emission is not carried out by the light-emitting unit. In this way, it is possible to prevent unnecessary shifting to the color tone connecting mode under conditions in which defects in the color tone of the pupils in the subject of photographing cannot arise.

Further, the photographing device of the first aspect of the present invention may further have a second prohibiting unit prohibiting shifting to the color tone correcting mode by the switching unit in a case in which the face detection photographing mode is prohibited. In this way, it is possible to prevent shifting to the color tone correcting mode in a state in which the face detection photographing mode is prohibited.

Moreover, the photographing device of the first aspect of the present invention may further have a display unit that carries out at least one display among a first display that, at a time of photographing the subject of photographing, displays a mark showing a photographing mode that is set at that point in time, and a second display that, at a time of playing-back photographed image information, displays a mark showing a photographing mode that was set in photographing that acquired that photographed image information. In this way, it is possible to facilitate at least one of, at a time of photographing the subject of photographing, grasping the photographing mode that is set at that point in time, and, at a time of playing-back photographed image information, grasping the photographing mode that was set in the photographing that acquired that photographed image information.

As described above, in accordance with the present invention, there is the excellent effect that switching to a color tone correcting mode that corrects color tone defects can be carried out without leading to an increase in cost and an increase in size.

### BRIEF DESCRIPTION OF THE DRAWINGS

FIG. 1 is an exterior view showing the exterior of a digital camera relating to an exemplary embodiment;

FIG. 2 is a block diagram showing the structure of main portions of the electrical system of the digital camera relating to the exemplary embodiment;

FIG. 3 is a drawing showing examples of display states of a screen that is displayed on an LCD in a case in which a face detection control switch is pushed and operated at the digital camera relating to the exemplary embodiment;

FIG. 4 is a drawing showing examples of display states of a screen that is displayed on the LCD in a case in which the face detection control switch is pushed and operated, at a time of switching to a photographing mode in which light emission by a flash is not carried out at the digital camera relating to the exemplary embodiment;

FIG. 5 is a flowchart showing the flow of processings of a photographing mode setting program relating to the exemplary embodiment;

FIGS. 6A and 6B are drawings showing photographing modes that the LCD displays at a time of photographing a subject of photographing relating to the exemplary embodiment;

FIGS. 7A and 7B are drawings showing photographing modes that the LCD displays at a time of playing-back photographed image information relating to the exemplary embodiment; and

FIG. 8 is a drawing showing examples of display states of a screen that is displayed on the LCD in a case in which the face detection control switch is pushed and operated.

### DETAILED DESCRIPTION OF THE INVENTION

An exemplary embodiment of the present invention will be described in detail hereinafter with reference to the drawings. Note that, in the present exemplary embodiment, a case is described in which the present invention is applied to a digital electronic still camera (hereinafter called “digital camera”).

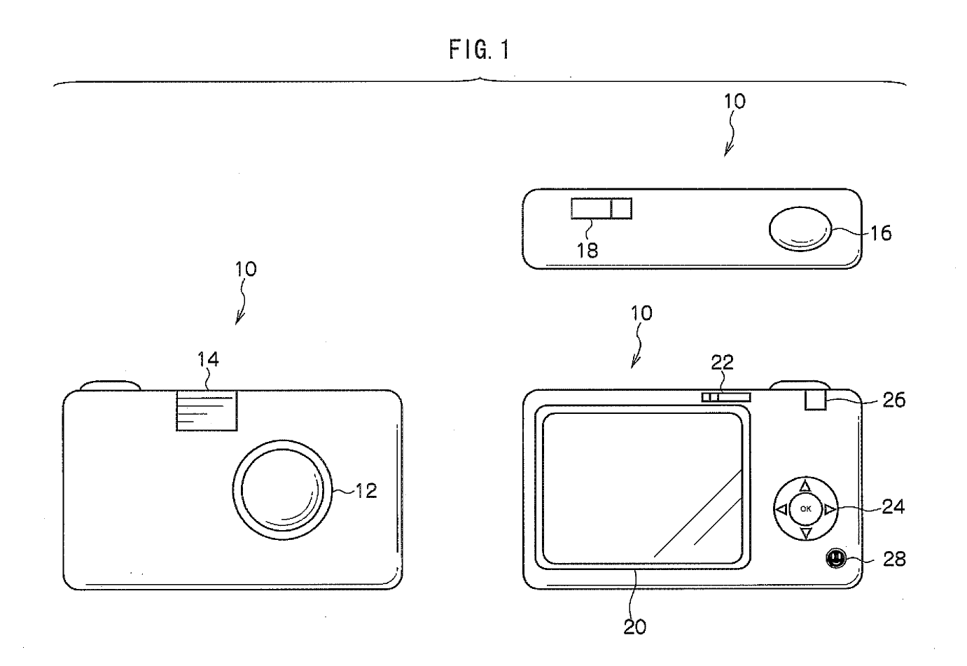

First, the structure of the exterior of a digital camera 10 relating to the present exemplary embodiment will be described with reference to FIG. 1.

As shown in FIG. 1, a lens 12 for focusing the image of the subject of photographing, and a flash 14 that carries out light-emission for compensating for an insufficient light amount at the time of photographing the subject of photographing, are provided at the front surface of the digital camera 10. Further, a release switch (a so-called shutter) 16 which is pushed and operated by a user at the time of executing photographing, and a power source switch 18 are provided at the top surface of the digital camera 10.

The release switch 16 relating to the present exemplary embodiment is structured such that the following two stages of the operation of pushing the release switch 16 can be detected: a state in which the release switch 16 is pushed to an intermediate position (hereinafter called “half-depressed state”), and a state in which the release switch 16 is pushed to a final pushed position which is past the intermediate position (hereinafter called “fully-depressed state”). Further, in the digital camera 10 relating to the present exemplary embodiment, by setting the release switch 16 in the half-depressed state, an AE (Automatic Exposure) function works such that the exposure state (the shutter speed, the state of the diaphragm) is set, and thereafter, an AF (Auto Focus) function works such that focusing is controlled. Thereafter, by continuing to push and setting the release switch 16 in the fully-depressed state, an instruction to execute photographing is inputted, and exposure (photographing) is carried out.

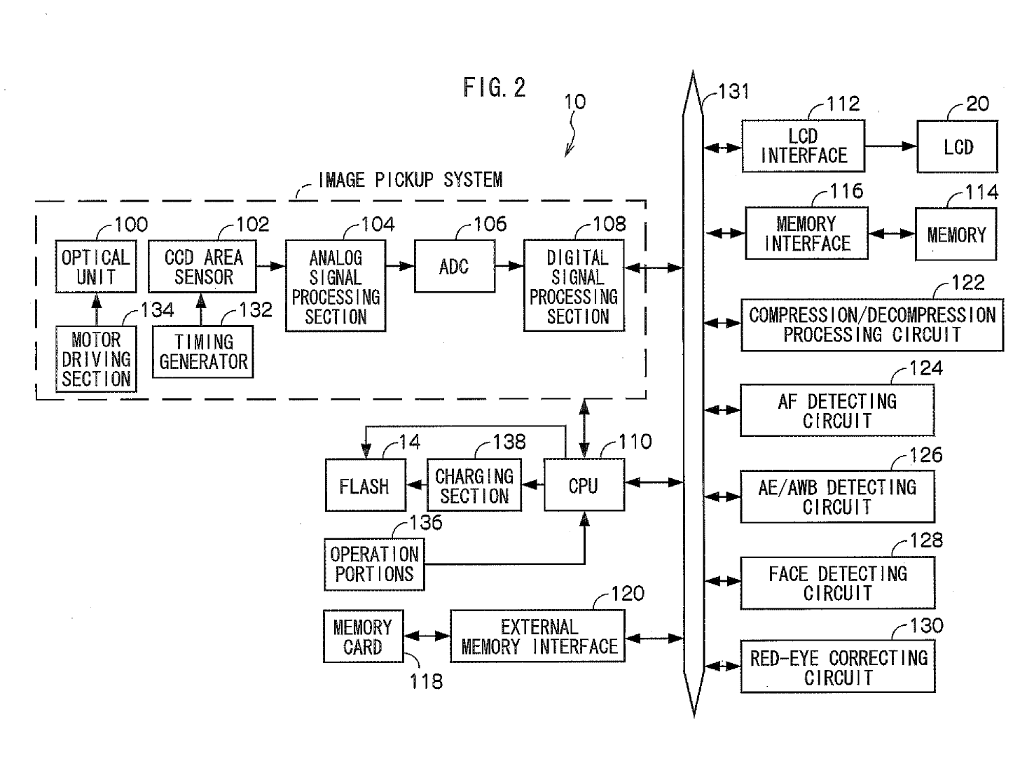

On the other hand, at the rear surface of the digital camera 10, there are provided: a liquid crystal display (hereinafter called “LCD”) 20 for displaying the image of the subject of photographing that is expressed by photographed image information acquired by photographing, various types of menu screens, messages, and the like; a mode switching switch 22 that is operated at the time of switching to either of a photographing mode that is a mode that carries out photographing, or a playback mode that is a mode that plays-back on the LCD 20 the image of the subject of photographing expressed by the image information acquired by photographing; a cross cursor switch 24 structured so as to include four arrow keys expressing directions of movement which are the four directions of up, down, left, right in the display region of the LCD 20; a forced light-emission switch 26 that is operated when shifting to a forced light-emitting mode that is a mode that forcibly causes the flash 14 to emit light at the time of photographing thereafter, and when reverting from the forced light-emitting mode; and a face detection control switch 28 operated at the time of switching the photographing mode between a face detection photographing mode that carries out photographing and obtains image information (hereinafter called “photographed image information”) under photographing conditions that are based on a face region that is the region of the face of a person detected by a face detecting circuit 128 (refer to FIG. 2 as well), which will be described later, at the time when the release switch 16 is set in the fully-depressed state, and an ordinary photographing mode that carries out photographing and obtains photographed image information without carrying out detection of the face region at the time when the release switch 16 is set in the fully-depressed state.

The structure of the main portions of the electrical system of the digital camera 10 relating to the present exemplary embodiment will be described next with reference to FIG. 2.

As shown in FIG. 2, the digital camera 10 is structured to include: an optical unit 100 that is structured to include the lens 12; a CCD area sensor 102 disposed at the rear of the lens 12 in the optical axis direction; and an analog signal processing section 104 that carries out various types of analog signal processing on inputted analog signals.

Further, the digital camera 10 is structured to include: an analog/digital converter (hereinafter called “ADC”) 106 that converts an inputted analog signal into digital information; and a digital signal processing section 108 that carries out various types of digital signal processing on inputted digital information.

The digital signal processing section 108 incorporates therein a line buffer of a predetermined capacity, and also carries out control so as to cause inputted digital information to be stored directly in a predetermined region of a memory 114 that will be described later.

The output end of the CCD area sensor 102 is connected to the input end of the analog signal processing section 104, the output end of the analog signal processing section 104 is connected to the input end of the ADC 106, and the output end of the ADC 106 is connected to the input end of the digital signal processing section 108. Accordingly, the analog signal, that is outputted from the CCD area sensor 102 and expresses the image of the subject of photographing, is subjected to predetermined analog signal processing by the analog signal processing section 104, and is converted into digital image information by the ADC 106, and thereafter, is inputted to the digital signal processing section 108.

On the other hand, the digital camera 10 is structured to include: an LCD interface 112 that generates signals for displaying the image of the subject of photographing, menu screens, and the like on the LCD 20, and supplies the signals to the LCD 20; a CPU (Central Processing Unit) 110 that governs overall operation of the digital camera 10; the memory 114 that temporarily stores the digital image information acquired by image pickup, and the like; and a memory interface 116 that carries out control of access to the memory 114.

Further, the digital camera 10 is structured to include an external memory interface 120 for allowing a portable memory card 118 to be accessed at the digital camera 10; a compression/decompression processing circuit 122 that carries out compression processing and decompression processing on photographed image information; an AF detecting circuit 124 detecting a physical amount that is needed in order to cause the AF function to work (in the present exemplary embodiment, a contrast evaluation value of the image obtained by image pickup by the CCD area sensor 102); and an AE/AWB detecting circuit 126 that detects a physical amount needed in order to cause the AE function and an AWB (Automatic White Balance) function to work (in the present exemplary embodiment, an amount expressing the brightness of the image obtained by image pickup by the CCD area sensor 102).

The digital camera 10 also has: a face detecting circuit 128 that detects the face region of a person from the subject of photographing that is expressed by the digital image information acquired by the CCD area sensor 102; and a red-eye correcting circuit 130 that carries out red-eye correction in a case in which red-eye arises in pupil regions that are the regions of the pupils of the person in the subject of photographing expressed by the photographed image information.

Note that the face detecting circuit 128 relating to the present exemplary embodiment, for example, determines and stores in advance a range of color difference signals that correspond to flesh colors of persons, and judges whether or not the color difference signals of the respective pixels of the digital image information expressing the image of the subject of photographing acquired by image pickup by the CCD area sensor 102 are within this range, and extracts, as a flesh-colored region, a region that is a group of pixels that are flesh-colored. Next, the face detecting circuit 128 judges whether or not patterns that are not flesh-colored, such as eyes, a nose, a mouth, eyebrows or the like, are included in the extracted flesh-colored region. If such patterns are included, the face detecting circuit 128 judges the flesh-colored region to be a face region. Note that the method of detecting the face region is not limited to this, and another conventionally known method may be used.

Further, in a case in which small regions of a color difference range corresponding to the colors of red-eye exist within the pupil regions of a person in the subject of photographing expressed by the photographed image region, the red-eye correcting circuit 130 relating to the present exemplary embodiment judges that red-eye has arisen, and carries out red-eye correction that converts these small regions into a color (e.g., black) that can be applied as the color of a person's pupils. The photographing mode that executes red-eye correction on photographed image information in this way is called a red-eye correcting mode. Note that the red-eye correction method is not limited to this, and another conventionally known method may be used.

The digital signal processing section 108, the LCD interface 112, the CPU 110, the memory interface 116, the external memory interface 120, the compression/decompression processing circuit 122, the AF detecting circuit 124, the AE/AWB detecting circuit 126, the face detecting circuit 128 and the red-eye correcting circuit 130 are connected together via a system bus 131. Accordingly, the CPU 110 can carry out control of the operations of the digital signal processing section 108, the compression/decompression processing circuit 122, the face detecting circuit 128 and the red-eye correcting circuit 130, and display of various types of information on the LCD 20 via the LCD interface 112, and access to the memory 114 and the memory card 118 via the memory interface 116 and the external memory interface 120.

On the other hand, a timing generator 132, that mainly generates timing signals for driving the CCD area sensor 102 and supplies the signals to the CCD area sensor 102, is provided at the digital camera 10. The driving of the CCD area sensor 102 is controlled by the CPU 110 via the timing generator 132.

Moreover, a motor driving section 134 is provided at the digital camera 10. The driving of a focal point adjusting motor, a zoom motor and a diaphragm driving motor, that are provided at the optical unit 100 and are not illustrated, also is controlled by the CPU 110 via the motor driving section 134.

On the other hand, the various types of switches (collectively called “operation portions 136” in FIG. 2), which are the release switch 16, the power source switch 18, the mode switching switch 22, the cross cursor switch 24, the forced light-emission switch 26 and the face detection control switch 28, are connected to the CPU 110. The CPU 110 can always grasp the states of operations with respect to these operation portions 136.

A charging section 138, that is interposed between the flash 14 and the CPU 110 and that, due to the control of the CPU 110, charges electric power for causing the flash 14 to emit light, is provided at the digital camera 10. Further the flash 14 is also connected to the CPU 110, and the emitting of light by the flash 14 is controlled by the CPU 110.

Note that, in a case in which the forced light-emitting mode is set by the forced light-emission switch 26, the CPU 110 forcibly causes the flash 14 to emit light at the time of photographing. Further, also in cases in which the forced light-emitting mode is not set, the CPU 110 causes the flash 14 to emit light if the brightness of the subject of photographing expressed by the digital image information acquired via the CCD area sensor 102 is lower than a predetermined level.

The digital camera 10 relating to the present exemplary embodiment corresponds to the Exif (Exchangeable Image File Format) standard, and the photographed image information obtained by carrying out photographing is stored in the memory card 118 as an Exif electronic file (image file). Further, information, that relates to the photographing mode which was set at the time of the photographing that acquired that photographed image information, is stored in a tag region included in the Exif image file.

Next, the overall operation at the time of photographing of the digital camera 10 relating to the present exemplary embodiment will be described briefly.

First, the CCD area sensor 102 carries out image pickup via the optical unit 100, and successively outputs, to the analog signal processing section 104, analog signals of R (red), G (green), and B (blue) that express the image of the subject of photographing. The analog signal processing section 104 carries out analog signal processings, such as correlated double sampling processing and the like, on the analog signals inputted from the CCD area sensor 102, and thereafter, successively outputs the processed signals to the ADC 106.

The ADC 106 converts the R, G, B analog signals inputted from the analog signal processing section 104 into, for example, 12-bit R, G, B signals respectively (digital image information), and successively outputs the signals to the digital signal processing section 108. The digital signal processing section 108 accumulates the digital image information, that is successively inputted from the ADC 106, in the line buffer that is incorporated in the digital signal processing section 108, and directly stores the digital image information in a predetermined region of the memory 114 temporarily.

The digital image information, that is stored in the predetermined region of the memory 114, is read-out by the digital signal processing section 108 in accordance with control by the CPU 110. The digital signal processing section 108 carries out white balance adjustment by applying a digital gain that is based on a predetermined physical amount, and carries out gamma processing and sharpness processing, and generates digital image information of a predetermined number of bits, e.g., 8 bits.

Then, the digital signal processing section 108 carries out YC signal processing on the generated digital image information of the predetermined number of bits, and generates a luminance signal Y and chroma signals Cr, Cb hereinafter called “YC signals”). The digital signal processing section 108 stores the YC signals in a region of the memory 114 that is different than the aforementioned predetermined region.

Note that the LCD 20 is structured so as to be able to be used as a finder and display moving images (through images) that are acquired by continuous image pickup by the CCD area sensor 102. In a case in which the LCD 20 is used as a finder, the generated YC signals are successively outputted to the LCD 20 via the LCD interface 112. Through images are thereby displayed on the LCD 20.

In a case in which the release switch 16 is set in the half-depressed state by a user, after the AE function works and the exposure state is set as described above, the AF function works and focus control is carried out. At this time, in a case in which the mode is shifted to the face detection photographing mode by operation with respect to the face detection control switch 28, photographing is carried out under photographing conditions that are based on a face region detected from the subject of photographing that is expressed by the digital image information. Specifically, setting of the exposure state and adjustment of the white balance adjustment are carried out on the basis of the brightness of the detected face region, and focus control is carried out on the basis of a contrast evaluation value of the detected face region. Thereafter, if pushing of the release switch 16 is continued such that the release switch 16 is set in the fully-depressed state, the YC signals stored in the memory 114 at that point in time are acquired, and are compressed in a predetermined compression format (JPEG in the present exemplary embodiment) by the compression/decompression processing circuit 122, and thereafter, are recorded in the memory card 118 via the external memory interface 120.

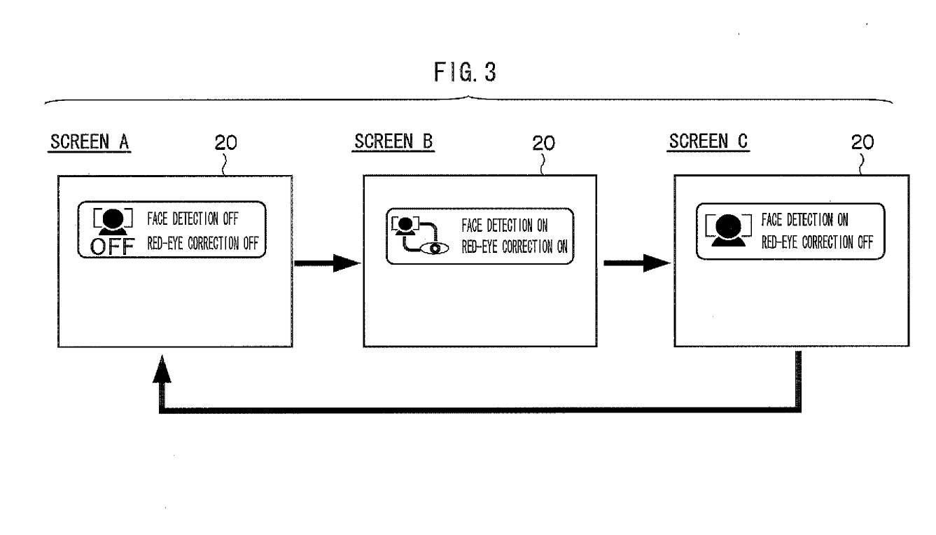

In the digital camera 10 relating to the present exemplary embodiment, the photographing mode is switched due to the face detection control switch 28 being operated as described above. An example of the changes in the display state of the LCD 20 at this time is shown in FIG. 3.

As shown in FIG. 3, in the digital camera 10 relating to the present exemplary embodiment, each time the face detection control switch 28 is pushed and operated, the screen displayed on the LCD 20 is switched between screen A, screen B and screen C. Screen A shows that there has been a shift to a photographing mode in which the ordinary photographing mode is implemented and the red-eye correcting mode is not implemented. (In the example shown in FIG. 3, “face detection OFF” and “red-eye correction OFF” are displayed. This corresponds to a third photographing mode of the present invention, and hereinafter is called the “third photographing mode”.) Screen B shows that there has been a shift to a photographing mode in which the face detection photographing mode and the red-eye correcting mode are implemented. (In the example shown in FIG. 3, “face detection ON” and “red-eye correction ON” are displayed. This corresponds to a first photographing mode of the present invention, and hereinafter is called the “first photographing mode”.) Screen C shows that there has been a shift to a photographing mode in which the face detection photographing mode is implemented and the red-eye correcting mode is not implemented. (In the example shown in FIG. 3, “face detection ON” and “red-eye correction OFF” are displayed. This corresponds to a second photographing mode of the present invention, and hereinafter is called the “second photographing mode”.)

The photographing mode is a photographing mode that does not suppose that the face of a person is photographed, e.g., is a scene photographing mode that is applied to cases in which a scene is photographed, a macro photographing mode that is applied to close-up photographing of flowers, insects, and the like, or the like. In a case in which the face detection photographing mode is prohibited, shifting to the red-eye correcting mode is prohibited. Therefore, the mode is fixed at the photographing mode shown by screen A in FIG. 3, regardless of how the face detection control switch 28 is pushed and operated.

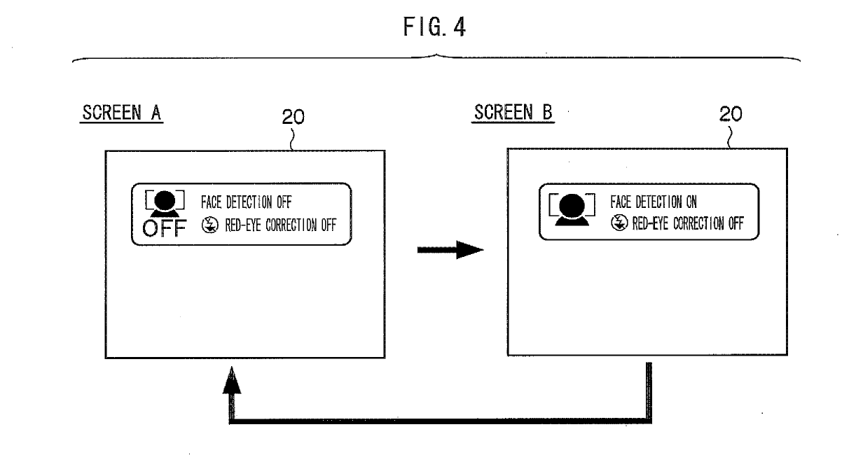

On the other hand, FIG. 4 shows examples of display states of the LCD 20 that change due to the face detection control switch 28 being pushed and operated at the time when the mode is switched to a flash emission prohibiting photographing mode that is a photographing mode in which emission of light by the flash 14 is not carried out.

In this case, each time the face detection control switch 28 is pushed and operated, the screen displayed on the LCD 20 is switched between screen A in FIG. 4 and screen B in FIG. 4. Screen A in FIG. 4 shows that there has been a shift to the third photographing mode in which the ordinary photographing mode is implemented and the red-eye correcting mode is not implemented. (In the example shown in FIG. 4, “face detection OFF” and “red-eye correction OFF” are displayed.) Screen B in FIG. 4 shows that there has been a shift to the second photographing mode in which the face detection photographing mode is implemented and the red-eye correcting mode is not implemented. (In the example shown in FIG. 4, “face detection ON” and “red-eye correction OFF” are displayed.)

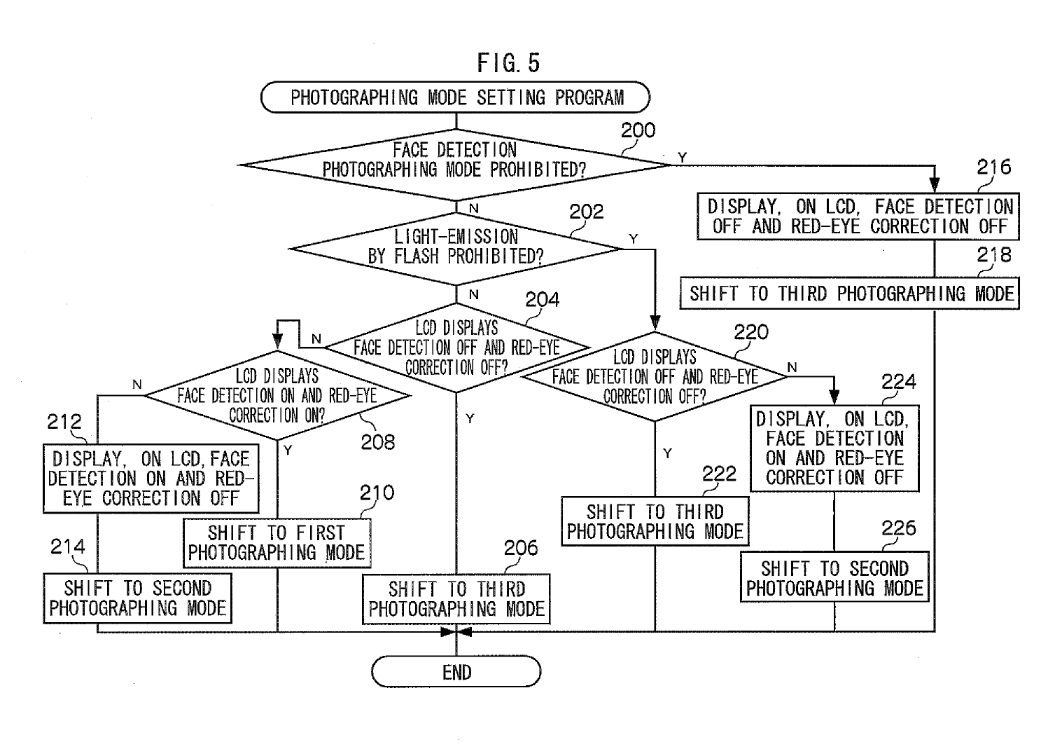

Operation at the time when the face detection control switch 28 is pushed and operated will be described next with reference to the flowchart shown in FIG. 5. Note that FIG. 5 is a flowchart showing the flow of interruption processing that is executed at the CPU 100 of the digital camera 10 at this time.

First, in step 200 of FIG. 5, it is judged whether or not a photographing mode, in which the face detection photographing mode is prohibited, is set. If the judgment is negative, the routine moves on to next step 202, whereas if the judgment is affirmative, the routine moves on to step 216.

In step 202, it is judged whether or not a photographing mode, in which light-emission by the flash 14 is not carried out, is set. If the judgment is affirmative, the routine moves on to step 220, whereas if the judgment is negative, the routine moves on to step 204.

In step 204, it is judged whether or not the screen that shows face detection and red-eye correction OFF (screen A of FIG. 3) is displayed on the LCD 20. If the judgment is affirmative, the routine moves on to step 206, whereas if the judgment is negative, the routine moves on to step 208.

In step 206, the mode shifts to the third photographing mode in which the ordinary photographing mode is executed and the red-eye correcting mode is not executed. Thereafter, the present photographing mode setting program ends.

In step 208, it is judged whether or not the screen that shows face detection and red-eye correction ON (screen B in FIG. 3) is displayed on the LCD 20. If the judgment is affirmative, the routine moves on to step 210, whereas if the judgment is negative, the routine moves on to step 212.

In step 210, the mode shifts to the first photographing mode in which the face detection photographing mode is executed and the red-eye correcting mode is executed. Thereafter, the present photographing mode setting program ends.

In step 212, the screen that shows face detection ON and red-eye correction OFF (screen C in FIG. 3) is displayed on the LCD 20. In next step 214, the mode shifts to the second photographing mode in which the face detection photographing mode is executed and the red-eye correcting mode is not executed. Thereafter, the present photographing mode setting program ends.

On the other hand, in step 216, the screen that shows face detection and red-eye correction OFF (screen A of FIG. 3) is displayed on the LCD 20. In next step 218, the mode shifts to the third photographing mode in which the ordinary photographing mode is executed and the red-eye correcting mode is not executed. Thereafter, the present photographing mode setting program ends.

On the other hand, in step 220, it is judged whether or not the screen that shows face detection and red-eye correction OFF (screen A of FIG. 4) is displayed on the LCD 20. If the judgment is affirmative, the routine moves on to step 222, whereas if the judgment is negative, the routine moves on to step 224.

In step 222, the mode shifts to the third photographing mode in which the ordinary photographing mode is executed and the red-eye correcting mode is not executed. Thereafter, the present photographing mode setting program ends.

In step 224, the screen that shows face detection ON and red-eye correction OFF (screen B in FIG. 4) is displayed on the LCD 20. In next step 226, the mode shifts to the second photographing mode in which the face detection photographing mode is executed and the red-eye correcting mode is not executed. Thereafter, the present photographing mode setting program ends.

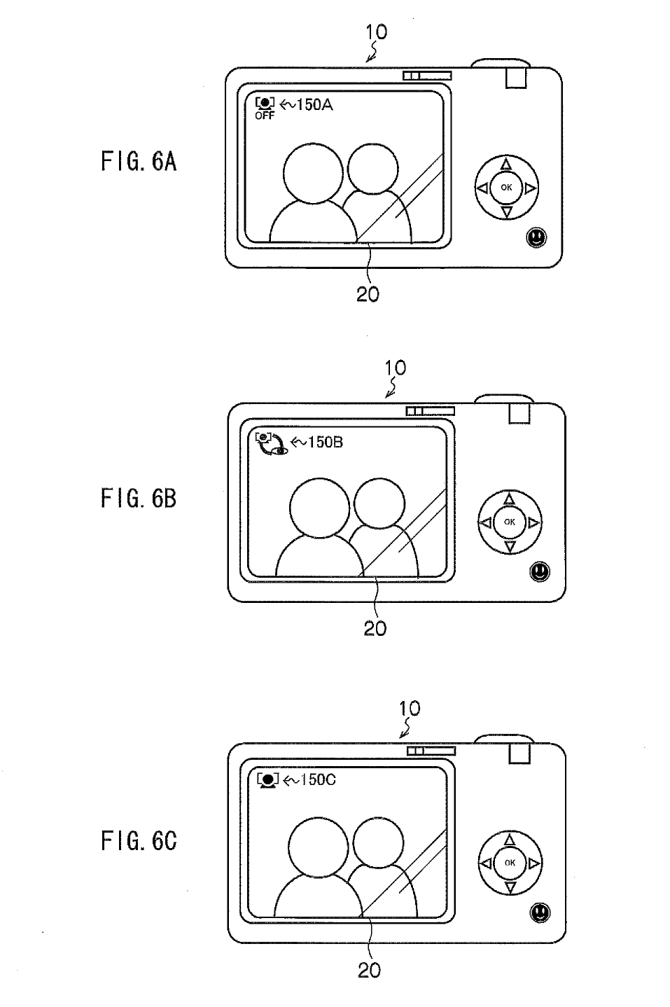

Next, the LCD 20 that displays a mark (icon) expressing the photographing mode that is set at the point in time when a subject of photographing is photographed, will be described with reference to FIG. 6A through FIG. 6C.

FIG. 6A illustrates a case in which the photographing mode that is set is the third photographing mode. In this case, the LCD 20 displays a mark 150A that expresses this fact at the upper left side thereof. Further, FIG. 6B illustrates a case in which the photographing mode that is set is the first photographing mode. In this case, the LCD 20 displays a mark 150B that expresses this fact at the upper left side thereof. Moreover, FIG. 6C illustrates a case in which the photographing mode that is set is the second photographing mode. In this case, the LCD 20 displays a mark 150C expressing this fact at the upper left side thereof.

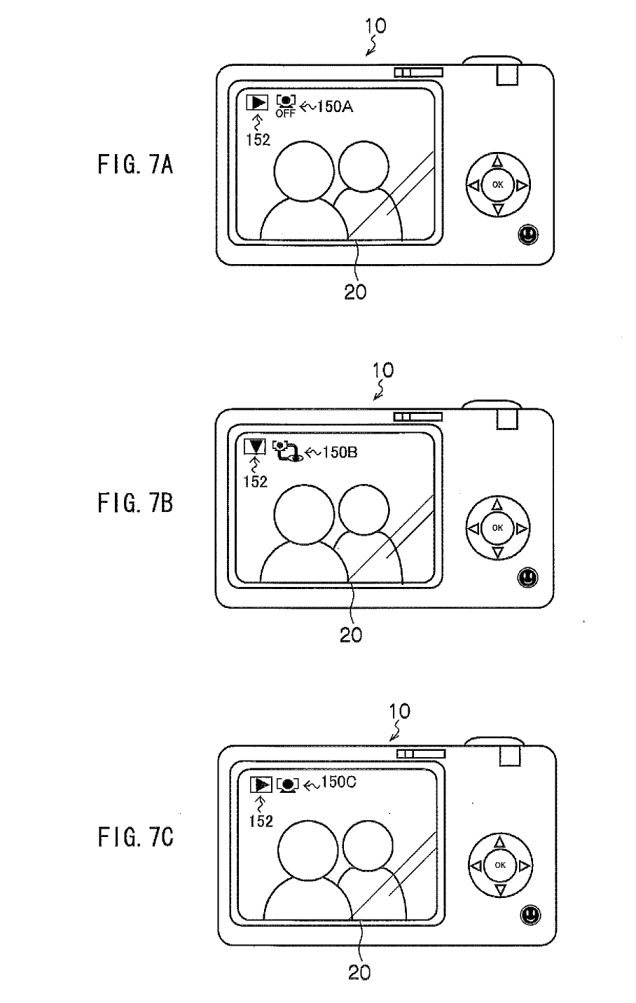

Next, the LCD 20 that, at the time of playing-back photographed image information, displays a mark (icon) expressing the photographing mode that was set in the photographing that acquired that photographed image information, will be described with reference to FIG. 7A through FIG. 7C. At this time, the photographed image information that the LCD 20 plays-back, and the information relating to the photographing mode for that photographed image information, are read-out from the Exif image file, and the mark to be displayed on the LCD 20 is determined on the basis of the information relating to that photographing mode.

FIG. 7A illustrates a case in which the photographing mode, that was set in the photographing that acquired the photographed image information that the LCD 20 is playing-back, was the third photographing mode. In this case, the LCD 20 displays the mark 150A and a mark 152, that expresses playback of photographed image information, at the upper left side of the LCD 20. Further, FIG. 7B illustrates a case in which the photographing mode, that was set in the photographing that acquired the photographed image information that the LCD 20 is playing-back, was the first photographing mode. In this case, the LCD 20 displays the mark 150B together with the mark 152 at the upper left side thereof. Moreover, FIG. 7C illustrates a case in which the photographing mode, that was set in the photographing that acquired the photographed image information that the LCD 20 is playing-back, was the second photographing mode. In this case, the LCD 20 displays the mark 150C together with the mark 152 at the upper left side thereof.

As described above, in the present exemplary embodiment, a subject of photographing is picked-up and image information expressing that subject of photographing is acquired by a image pickup unit (here, the CCD area sensor 102). A face region, that is the region of the face of a person, is detected by a face detecting unit (here, the face detecting circuit 128) from the subject of photographing that is expressed by the image information acquired by the image pickup unit. An operation portion (here, the face detecting control switch 28) is operated at the time of switching the photographing mode between the face detection photographing mode and the ordinary photographing mode. Shifting to a color tone correcting mode, that carries out correction of color tone defects in a case in which color tone defects arise in pupil regions that are regions of the pupils of a person in the subject of photographing that is expressed by photographed image information, and reverting from the color tone correcting mode, can be switched between by a switching unit (here, the CPU 110) interlockingly with operation carried out with respect to the operation portion. Therefore, the color tone correcting mode, that carries out correction of color tone defects, can be switched to without leading to an increase in cost or size.

In the present exemplary embodiment, the operation portion is operated at the time of switching the photographing mode among a first photographing mode that implements a face detection photographing mode and a color tone correcting mode, a second photographing mode that implements the face detection photographing mode and does not implement the color tone correcting mode, and a third photographing mode that implements an ordinary photographing mode and does not implement the color tone correcting mode. Therefore, the photographing mode can be switched among the first photographing mode, the second photographing mode, and the third photographing mode, without leading to an increase in cost or size.

In the present exemplary embodiment, the operation portion is operated at the time of switching the photographing mode between the first photographing mode that implements the face detection photographing mode and the color tone correcting mode, and the third photographing mode that implements the ordinary photographing mode and does not implement the color tone correcting mode. Therefore, the photographing mode can be switched between the first photographing mode and the third photographing mode, without leading to an increase in cost or size.

Further, in the present exemplary embodiment, there is further provided a light-emitting unit that carries out light-emission for compensating for an insufficient light amount at the time of photographing a subject of photographing. There is also further provided a first prohibiting unit (here, the CPU 110) that prohibits a shift to the color tone correcting mode by the switching unit, in a case in which light-emission is not carried out by the light-emitting unit (here, the flash 14). Therefore, it is possible to prevent unnecessary shifting to the color tone correcting mode under conditions in which defects in the color tone of the pupils in the subject of photographing cannot arise.

Moreover, the present exemplary embodiment is further provided with a second prohibiting unit (here, the CPU 110) that prohibits shifting to the color tone correcting mode by the switching unit in a case in which the face detection photographing mode is prohibited. Therefore, it is possible to prevent a shift to the color tone correcting mode in a case in which the face detection photographing mode is prohibited.

Still further, the present exemplary embodiment is further provided with the display unit that carries out at least one display of a first display (here, the LCD 20) that, at the time of photographing a subject of photographing, displays a mark indicating the photographing mode that is set at that point in time, and a second display (here, the LCD 20) that, at the time of playing-back photographed image information, displays a mark indicating the photographing mode that was set in the photographing that acquired that photographed image information. Therefore, it is possible to facilitate at least one of, when photographing a subject of photographing, grasping the photographing mode that is set at that point in time, and, when playing-back photographed image information, grasping the photographing mode that was set in the photographing that acquired that photographed image information.

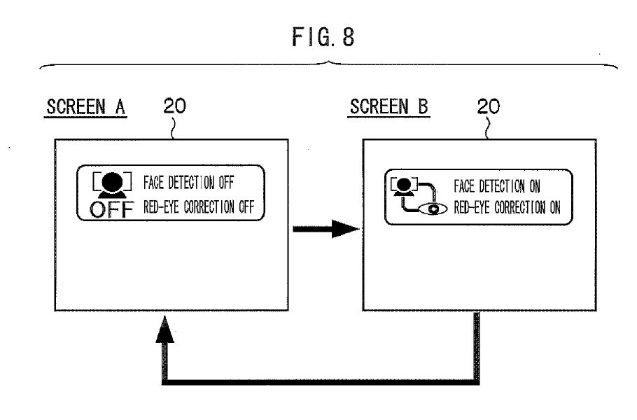

As shown in FIG. 3, the present exemplary embodiment describes a case in which, each time the face detection control switch 28 is pushed and operated, the photographing mode is switched among the three types of photographing modes that are the first photographing mode, the second photographing mode and the third photographing mode. However, the present invention is not limited to this. For example, as shown as an example in FIG. 8, a form is also possible in which, each time the face detection control switch 28 is pushed and operated, the photographing mode is switched between two types of photographing modes that are screen A, that shows that the mode has been shifted to the third photographing mode, and screen B, that shows that the mode has been shifted to the first photographing mode. In this case as well, effects that are similar to those of the present exemplary embodiment can be exhibited.

Further, the present exemplary embodiment describes a case in which the photographing mode is switched at the time when the face detection control switch 28 is operated. However, the present invention is not limited to this. For example, a form is also possible in which, after the screen showing the photographing mode is displayed after the shift at the time when the face detection control switch 28 is operated, the photographing mode is switched at the time that a decision switch other than the face detection control switch 28 is operated. In this case, the user can confirm the change in the photographing mode, and the convenience of use can be improved.

The present exemplary embodiment describes a case in which the photographed image information and information, that relates to the photographing mode set at the time of the photographing that acquired that photographed image information, are stored in association with one another by using the tag region of an Exif image file. However, the present invention is not limited to this. For example, a form in which the photographed image information and the photographing mode corresponding to the photographed image information are stored in association by an electronic file that is separate from the image file storing the photographed image information, or a form in which information expressing the photographing mode is embedded in the file name of the photographed image information, or the like also can be used. In these cases as well, effects that are similar to those of the present exemplary embodiment can be exhibited.

Cases of applying the marks shown in FIG. 6 and FIG. 7 as the shapes and the display forms of the marks of the present invention are described in the present exemplary embodiment. However, the present invention is not limited to this, and other shapes and display forms may of course be applied. In these cases as well, effects that are similar to those of the present exemplary embodiment can be exhibited.

Further, although the present exemplary embodiment describes a case in which the photographed image information before red-eye correction is not stored in the memory card 118, the present invention is not limited to this. A form can be used in which the photographed image information before red-eye correction is stored in addition to the photographed image information after red-eye correction. In this way, cases in which the red-eye correction was not carried out appropriately can be addressed, and the convenience of use can be improved.

Although the present exemplary embodiment describes a case in which the present invention is applied to a digital camera, the present invention is not limited to the same, and may of course be applied to other information devices having a photographing function such as, for example, digital video cameras, cell phones, PDAs, and the like.

Moreover, a case in which the face detection and red-eye correction are realized by hardware structures is described in the present exemplary embodiment, but the present invention is not limited to this. A form can be utilized in which the face detection and red-eye correction are realized by software structures in accordance with computer programs. In this case, the above-described hardware structures can be omitted, and as a result, further cost reduction and compactness can be achieved as compared with the present exemplary embodiment.

What is claimed is:

1. A photographing device comprising:
an image pickup unit picking-up a subject of photographing and acquiring image information expressing the subject of photographing;
a face detecting unit detecting a face region, that is a region of a face of a person, from the subject of photographing expressed by the image information acquired by the image pickup unit;
an operation portion operated at a time of switching a photographing mode between a face detection photographing mode that, in a case in which a photographing execution instruction is inputted, carries out photographing that uses the image pickup unit and that is accompanied by detection of a face region by the face detecting unit, and obtains photographed image information, and an ordinary photographing mode that, in a case in which a photographing execution instruction is inputted, carries out photographing using the image pickup unit and without carrying out detection of the face region, and obtains photographed image information; and
a switching unit that, interlockingly with operation with respect to the operation portion, switches between shifting to a color tone correcting mode that carries out correction of color tone defects in a case in which the color tone defects arise in pupil regions that are regions of pupils of a person in the subject of photographing expressed by the photographed image information, and reverting from the color tone correcting mode.

2. The photographing device of claim 1, wherein the operation portion is operated at a time of switching a photographing mode among a first photographing mode that executes the face detection photographing mode and the color tone correcting mode, a second photographing mode that executes the face detection photographing mode and does not execute the color tone correcting mode, and a third photographing mode that executes the ordinary photographing mode and does not execute the color tone correcting mode.

3. The photographing device of claim 1, wherein the operation portion is operated at a time of switching a photographing mode between a first photographing mode that executes the face detection photographing mode and the color tone correcting mode, and a third photographing mode that executes the ordinary photographing mode and does not execute the color tone correcting mode.

4. The photographing device of claim 1, further comprising a light-emitting unit carrying out light emission for compensating for a light amount insufficiency at a time of photographing the subject of photographing, and a first prohibiting unit prohibiting shifting to the color tone correcting mode by the switching unit in a case in which the light emission is not carried out by the light-emitting unit.

5. The photographing device of claim 1, further comprising a second prohibiting unit prohibiting shifting to the color tone correcting mode by the switching unit in a case in which the face detection photographing mode is prohibited.

6. The photographing device of claim 1, further comprising a display unit that carries out at least one display among a first display that, at a time of photographing the subject of photographing, shows a photographing mode that is set at that point in time, and a second display that, at a time of playing-back photographed image information, shows a photographing mode that was set in photographing that acquired that photographed image information.

7. A photographing device comprising:
an image pickup unit picking-up a subject of photographing and acquiring image information expressing the subject of photographing;
a face detecting unit detecting a face region, that is a region of a face of a person, from the subject of photographing expressed by the image information acquired by the image pickup unit;
an operation portion operated in order to select either one of a face detection photographing mode that, in a case in which a photographing execution instruction is inputted, carries out photographing that uses the image pickup unit and that is accompanied by detection of a face region by the face detecting unit, and obtains photographed image information, and an ordinary photographing mode that, in a case in which a photographing execution instruction is inputted, carries out photographing using the image pickup unit and without carrying out detection of the face region, and obtains photographed image information; and
a controlling unit controlling workings of the photographing device corresponding to the one of the face detection photographing mode and the ordinary photographing mode that is selected by operation at the operation portion,
wherein the controlling unit includes a switching unit that, in accordance with operation carried out with respect to the operation portion, switches between shifting to a color tone correcting mode that carries out correction of color tone defects arising in pupil regions corresponding to regions of pupils of a person in the subject of photographing expressed by the photographed image information, and reverting from the color tone correcting mode.

8. The photographing device of claim 7, wherein, at the operation portion, a photographing mode switching operation is possible that selects one of a first photographing mode that executes the face detection photographing mode and the color tone correcting mode, a second photographing mode that executes the face detection photographing mode and does not execute the color tone correcting mode, and a third photographing mode that executes the ordinary photographing mode and does not execute the color tone correcting mode.

9. The photographing device of claim 7, wherein, at the operation portion, a photographing mode switching operation is possible that selects one of a first photographing mode that executes the face detection photographing mode and the color tone correcting mode, and a third photographing mode that executes the ordinary photographing mode and does not execute the color tone correcting mode.

10. The photographing device of claim 7, further comprising a light-emitting unit carrying out light emission for compensating for a light amount insufficiency at a time of photographing the subject of photographing, wherein the controlling unit prohibits the switching unit from shifting to the color tone correcting mode in a case in which the light emission is not carried out by the light-emitting unit.

11. The photographing device of claim 7, wherein the controlling unit prohibits the switching unit from shifting to the color tone correcting mode in a case in which the face detection photographing mode is not selected.

12. The photographing device of claim 7, further comprising a display unit that carries out at least one display among a first display that, at a time of photographing the subject of photographing, shows a photographing mode that is set at that point in time, and a second display that, at a time of playing-back photographed image information, shows a photographing mode that was set in photographing that acquired that photographed image information.
